(19) United States
(12) Patent Application Publication
(10) Pub. No.: US 2018/0080498 A1
(43) Pub. Date: Mar. 22, 2018

(54) PRE-SET ROLLING ELEMENT BEARING

(71) Applicant: Schaeffler Technologies AG & Co. KG, Herzogenaurach (DE)

(72) Inventors: Jonathan Murray, Troy, MI (US); Majkol Spirovski, Macomb Township, MI (US)

(73) Assignee: Schaeffler Technologies AG & Co. KG, Herzogenaurach (DE)

(21) Appl. No.: 15/267,196

(22) Filed: Sep. 16, 2016

(51) Int. Cl. F16C 25/06; F16C 19/18; F16C 19/38

(52) U.S. Cl. CPC F16C 25/06; F16C 2229/00; F16C 19/386; F16C 19/184

(57) ABSTRACT

A pre-set bearing assembly provides for a simplified installation within a rotating shaft system. The bearing assembly includes an outer ring, a first and a second inner ring, a first and a second row of rolling elements, and at least one coupling element that couples the first inner ring to the second inner ring, setting the pre-load or end-play of the bearing assembly to a pre-determined range. The outer ring includes a first outer rolling element raceway on a first inner radial surface and a second outer rolling element raceway on a second inner radial surface. The first inner ring includes a first inner rolling element raceway and the second inner ring includes a second inner rolling element raceway.

### TECHNICAL FIELD

Example aspects described herein relate to rolling element bearing assemblies, particularly of bearings that are used in pairs within rotating shaft systems.

### BACKGROUND

Rolling element bearing assemblies are typically circular in shape, and generally comprise of rolling elements, normally contained by a cage, disposed between inner and outer raceways. Rolling elements take many forms, including spherical balls, cylindrical rollers, needle rollers, or various other configurations, such as cone-shaped tapered rollers or barrel-shaped spherical rollers. Cages are often used to contain the rolling elements and guide them throughout the rotating motion of the bearing, but are not a necessity in some configurations. The material of a cage can vary from steel to plastic, depending on the application, duty cycle, along with noise and weight requirements.

The type of bearing used for a particular application depends on multiple factors including the load, load direction, required stiffness, and speed. Angular contact ball bearings and tapered roller bearings are known and are able to withstand combined radial and axial loads. Many applications require use of pairs of tapered roller or angular contact ball bearings to withstand axial loads in both directions. For these paired arrangements, it is typical practice to assemble the components of the bearings with a specified end-play (axial clearance) or pre-load (axial interference) for optimum bearing performance. The act of adjusting the end-play or pre-load to a targeted range is known in the art of rolling element bearings as “setting.” Setting the end-play or pre-load of a bearing or a pair of bearings requires valuable manufacturing time and can require sophisticated measurement equipment. A solution is required to simplify or eliminate the costly process of setting bearing end-play or pre-load.

### SUMMARY OF THE INVENTION

A pre-set bearing assembly provides for a simplified installation within a rotating shaft system. The bearing assembly includes an outer ring, a first and a second inner ring, a first and a second row of rolling elements, and at least one coupling element that couples the first inner ring to the second inner ring, setting an end-play or pre-load of the bearing assembly to a pre-determined range. The outer ring includes a first outer rolling element raceway on a first inner radial surface and a second outer rolling element raceway on a second inner radial surface. The first inner ring includes a first inner rolling element raceway on a first outer radial surface and the second inner ring includes a second inner rolling element raceway on a second outer radial surface. The first row of rolling elements is arranged together with an optional first cage between the first outer rolling element raceway of the outer ring and the first inner rolling element raceway of the first inner ring. The second row of rolling elements is arranged together with an optional second cage between the second outer rolling element raceway of the outer ring and the second inner rolling element raceway of the second inner ring. The first outer rolling element raceway and the first inner rolling element raceway are configured to receive a first axial load, while the second outer rolling element raceway and the second inner rolling element raceway are configured to receive a second axial load. In one aspect, the first and second rows of rolling elements can be tapered rollers, and, thus, the corresponding outer and inner rolling element raceways can be tapered roller raceways. In another aspect, the first and second rows of rolling elements can be balls, and, thus, the corresponding outer and inner rolling element raceways can be angular contact ball raceways.

The at least one coupling element can be a fastener disposed within at least one first aperture extending from a first axial face to a second axial face of the first inner ring, and at least one second aperture, aligned with the at least one first aperture, extending from a third axial face to a fourth axial face of the second inner ring. The at least one fastener can utilize threads that are configured within either of the at least one first aperture or the at least one second aperture, or a threaded nut. Torque can be applied to the at least one fastener to adjust the pre-load of the bearing assembly.

The at least one coupling element can also be a retaining clip disposed within at least one first groove extending from the first axial face to the second axial face of the first inner ring, and at least one second groove, aligned with the at least one first groove, extending from the third axial face to the fourth axial face of the second inner ring. At least one first landing can be configured on the second axial face to receive a first end of the at least one retention clip, and at least one second landing can be configured on the fourth axial face to receive a second end of the at least one retention clip. A distance between the at least one first landing and the at least one second landing can be measured and a retaining clip can be selected according to its measured length to adjust the end-play or pre-load of the bearing assembly to a pre-determined range.

The design of the bearing assembly can accommodate a ring disposed between the first and second inner rings that is compressed after pre-load of the bearing has been set. In addition, a gap can exist in absence of the ring, or the first axial face of the first inner ring can abut with the third axial face of the second inner ring after pre-load of the bearing has been set by the at least one coupling element.

### BRIEF DESCRIPTION OF DRAWINGS

The above mentioned and other features and advantages of the embodiments described herein, and the manner of attaining them, will become apparent and better understood by reference to the following descriptions of multiple example embodiments in conjunction with the accompanying drawings. A brief description of the drawings now follows.

FIG. 1 is a perspective view of a first example embodiment of a pre-set bearing assembly.

FIG. 2A is a perspective view of a first inner ring of the bearing assembly shown in FIG. 1.

FIG. 2B is a perspective view of the first inner ring and a second inner ring of the bearing assembly shown in FIG. 1.

FIG. 3 is a perspective view of the outer ring of the bearing assembly shown in FIG. 1.

FIG. 4A is a cross-sectional view of the bearing assembly shown in FIG. 1 in a non-pre-set condition.

FIG. 4B is a cross-sectional view of the bearing assembly shown in FIG. 1 in a pre-set condition with no gap between the first and second inner rings.

FIG. 4C is a cross-sectional view of the bearing assembly shown in FIG. 1 in a pre-set condition with a gap between the first and second inner rings.

FIG. 4D is a cross-sectional view of the bearing assembly shown in FIG. 1 in a pre-set condition with a ring between the first and second inner rings.

FIG. 5 is a perspective view of a second example embodiment of a pre-set bearing assembly.

FIG. 6 is a cross-sectional view of the bearing assembly of FIG. 5.

FIG. 7 is a perspective view of a third example embodiment of a pre-set bearing assembly.

FIG. 8 is a cross-sectional view of the bearing assembly of FIG. 7.

FIG. 9A is a perspective view of a coupling element in the form of a retaining clip.

FIG. 9B is a side view of the retaining clip shown in FIG. 9A.

### DETAILED DESCRIPTION OF THE INVENTION

Identically labeled elements appearing in different figures refer to the same elements but may not be referenced in the description for all figures. The exemplification set out herein illustrates at least one embodiment, in at least one form, and such exemplification is not to be construed as limiting the scope of the claims in any manner. A radially inward direction is from an outer radial surface of the outer raceway, toward the central axis or radial center of the outer raceway. Conversely, a radial outward direction indicates the direction from the central axis or radial center of the outer raceway toward the outer surface. Axially refers to directions along a diametric central axis. The words “left” and “right” designate directions in the drawings to which reference is made.

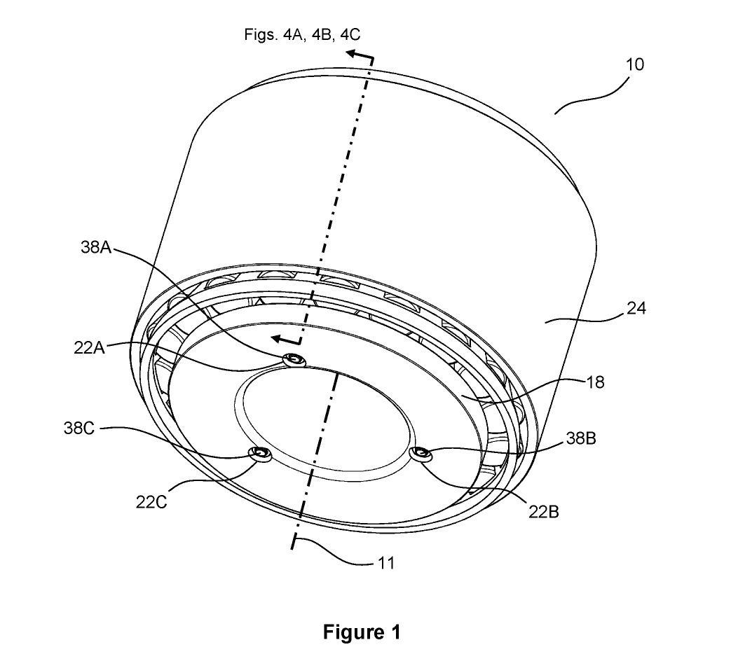

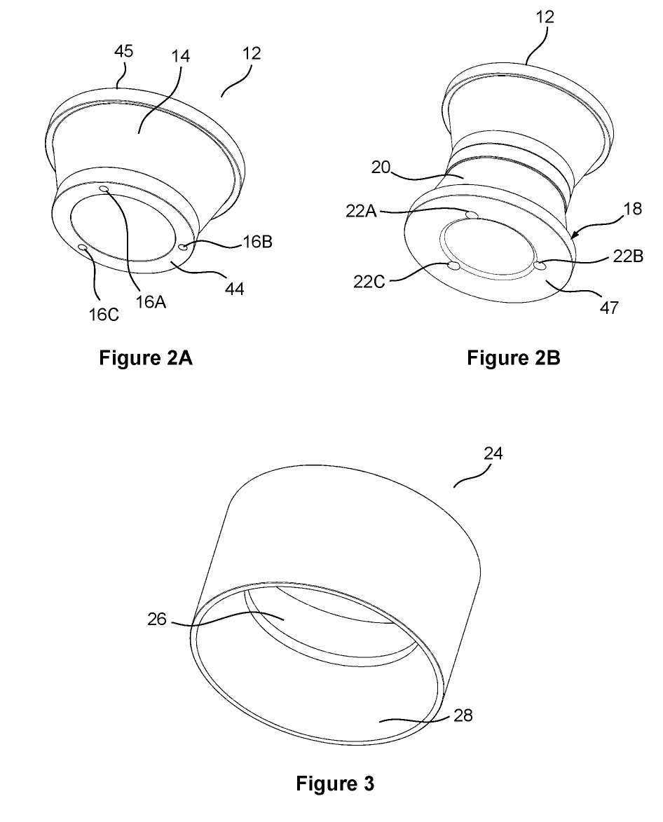

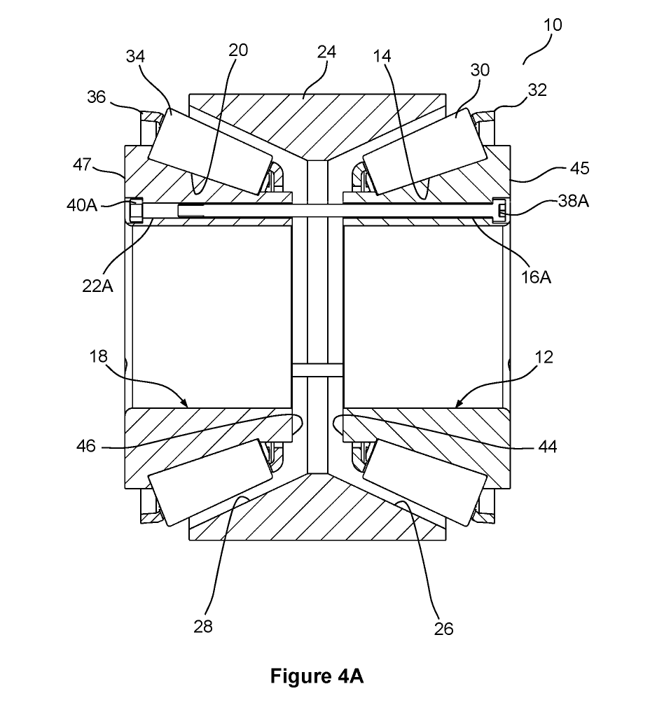

Referring to FIGS. 1 through 4D, a first example embodiment of a bearing assembly 10 is shown that rotates about central axis 11. The bearing assembly 10 includes a first inner ring 12, a second inner ring 18, and an outer ring 24. The first inner ring 12 has a first inner rolling element raceway or first inner tapered roller raceway 14 on a first inner radial surface, while the second inner ring 18 has a second inner rolling element raceway or second inner tapered roller raceway 20 on a second inner radial surface. The outer ring 24 has a first outer rolling element raceway or first outer tapered roller raceway 26 on a first inner radial surface and a second outer rolling element raceway or second outer tapered roller raceway 28 on a second inner radial surface. The first inner ring 12 includes first apertures 16A,16B,16C that extend from a first axial face 44 to a second axial face 45. The second inner ring 18 includes second apertures 22A,22B,22C that extend from a third axial face 46 to a fourth axial face 47. The second apertures 22A,22B,22C are aligned with the first apertures 16A,16B,16C. While FIGS. 2A and 2B show three apertures in each of the inner rings 12,18, the number of apertures can vary depending on the needs of the application. Disposed within the first apertures 16A,16B,16C and second apertures 22A,22B,22C are three coupling elements in the form of three fasteners 38A,38B,38C and three nuts 40A,40B,40C, (only 40A is shown) that set an end-play or pre-load of the bearing assembly 10. By providing a bearing assembly with the end-play or pre-load already set, assembly within a manufacturing environment is simplified while the duration of assembly is reduced.

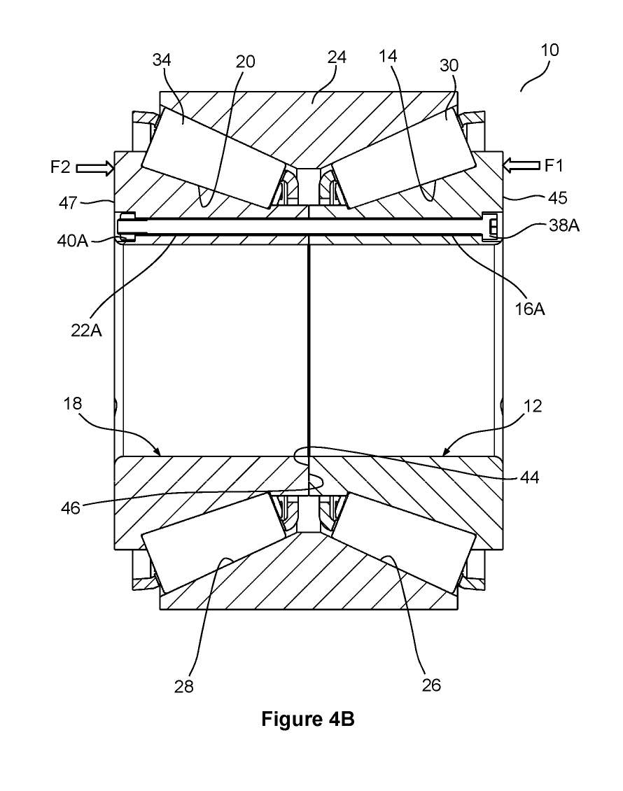

Referring to FIG. 4A, the bearing assembly 10 is shown loosely assembled. Rolling elements in the form of a first row of tapered rollers 30 and a second row of tapered rollers 34 are shown that reside between the outer tapered roller raceways 26,28 of the outer ring 24 and the inner tapered roller raceways 14,20 of the respective first and second inner rings 12,18. A first cage 32 is present to receive and circumferentially space the first row of tapered rollers 30 and a second cage 36 is present to receive and circumferentially space the second row of tapered rollers 34.

Referring to FIG. 4B, the bearing assembly 10 is fastened together by the three fasteners 38A,38B,38C and three nuts 40A,40B,40C (only one fastener 38A and one nut 40A are shown). In this assembled state, the end-play or pre-load of the bearing is set when the first axial face 44 of the first ring 12 abuts with the third axial face 46 of the second ring 18. The first inner tapered roller raceway 14 of the first inner ring 12 and the first outer tapered roller raceway 26 of the outer ring 24 are configured to receive a first axial load F1, as shown. Additionally, the second inner tapered roller raceway 20 of the second inner ring 18 and the second outer tapered roller raceway 28 of the outer ring 24 are configured to receive a second axial load F2, as shown. Therefore, the bearing assembly 10 is designed to receive bi-directional axial loading.

Referring to FIG. 4C, a first variation of the first example embodiment is shown. As in FIG. 4B, the bearing assembly 10′ is fastened together by the three fasteners 38A,38B,38C and nuts 40A,40B,40C (only one fastener 38A and one nut 40A are shown). However, in this assembled state, a variable gap X exists between the first axial face 44′ of the first inner ring 12′ and the third axial face 46′ of the second inner ring 18′, such that the end-play or pre-load of the bearing assembly 10′ can be adjusted by the tension of the three fasteners 38A,38B,38C.

Referring to FIG. 4D, a second variation of the first example embodiment is shown. As in FIGS. 4B and 4C, the bearing assembly 10″ is fastened together by the three fasteners 38A,38B,38C and nuts 40A,40B,40C (only one fastener 38A and one nut 40A are shown). A ring 42 is present between the first axial face 44″ of the first inner ring 12″ and the third axial face 46″ of the second inner ring 18″, such that the ring 42 is compressed upon tensioning of the fasteners 38A,38B,38C during the setting process of the end-play or pre-load. Different thicknesses T of the ring 42 are possible to achieve different settings of end-play or pre-load. In the case of a pre-load setting, the presence of the ring 42 can ensure that the prescribed pre-load is not exceeded, avoiding an excessive friction condition that would likely shorten bearing life. Additionally, the presence of the ring 42 can also facilitate a load path through the first and second inner rings 12″,18″, which can increase bearing stiffness.

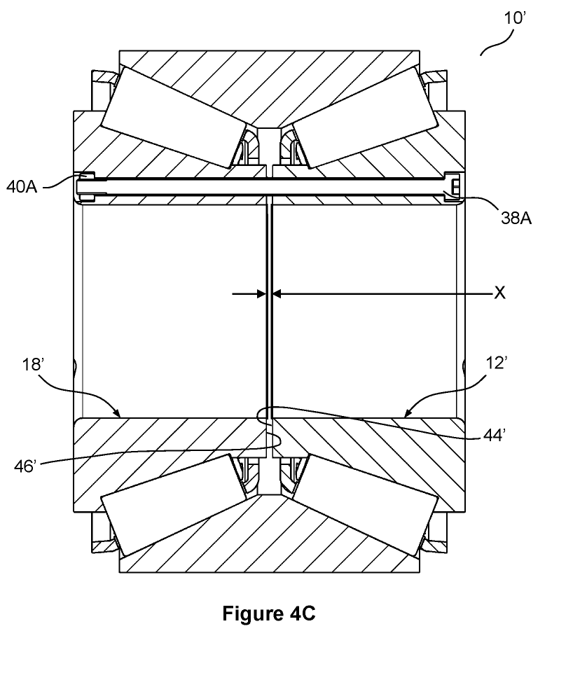

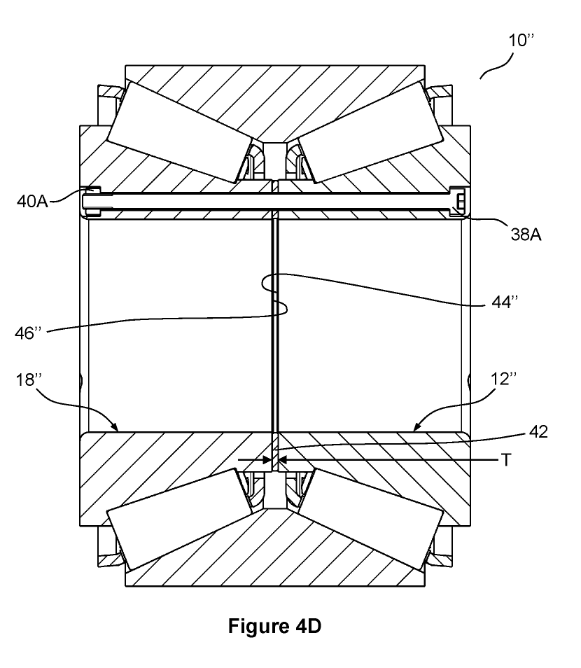

Referring now to FIGS. 5 and 6, a second example embodiment of a bearing assembly 50 is shown that rotates about central axis 51. In this second example embodiment, angular contact balls are utilized instead of tapered rollers as in the first example embodiment. The bearing assembly 50 includes a first inner ring 52, a second inner ring 58, and an outer ring 66. The first inner ring 52 has a first inner rolling element raceway or first angular contact ball raceway 54 on a first inner radial surface, while the second ring 58 has a second inner rolling element raceway or second inner angular contact ball raceway 60 on a second inner radial surface. The outer ring 66 has a first outer rolling element raceway or first outer angular contact ball raceway 65 on a first inner radial surface and a second outer rolling element raceway or second outer angular contact ball raceway 67 on a second inner radial surface. The first inner ring 52 includes first apertures 56A,56B,56C (only aperture 56A is shown) that extend from a first axial face 53 to a second axial face 55. The second inner ring 58 includes second apertures 62A,62B,62C that extend from a third axial face 59 to a fourth axial face 61. The second apertures 62A,62B,62C are aligned with the first apertures 56A,56B,56C. The number of apertures can vary depending on the needs of the application. Disposed within the first apertures 56A,56B,56C and second apertures 62A,62B,62C are three coupling elements in the form of three fasteners 38A,38B,38C and three nuts 40A,40B,40C (only 40A is shown) that set an end-play or pre-load of the bearing assembly 50. As in the first example embodiment, by providing a bearing assembly with the end-play or pre-load already set, assembly within a manufacturing environment is simplified while the duration of assembly is reduced.

The first and second example embodiments are shown with a fastener and threaded nut arrangement to adjust the end-play or pre-load of the respective bearing assemblies. The threaded nut could be eliminated with the application of threads to either end of the shown apertures to facilitate end-play or pre-load adjustment. Additionally, any suitable adjustable fastener or coupling element could also be applied.

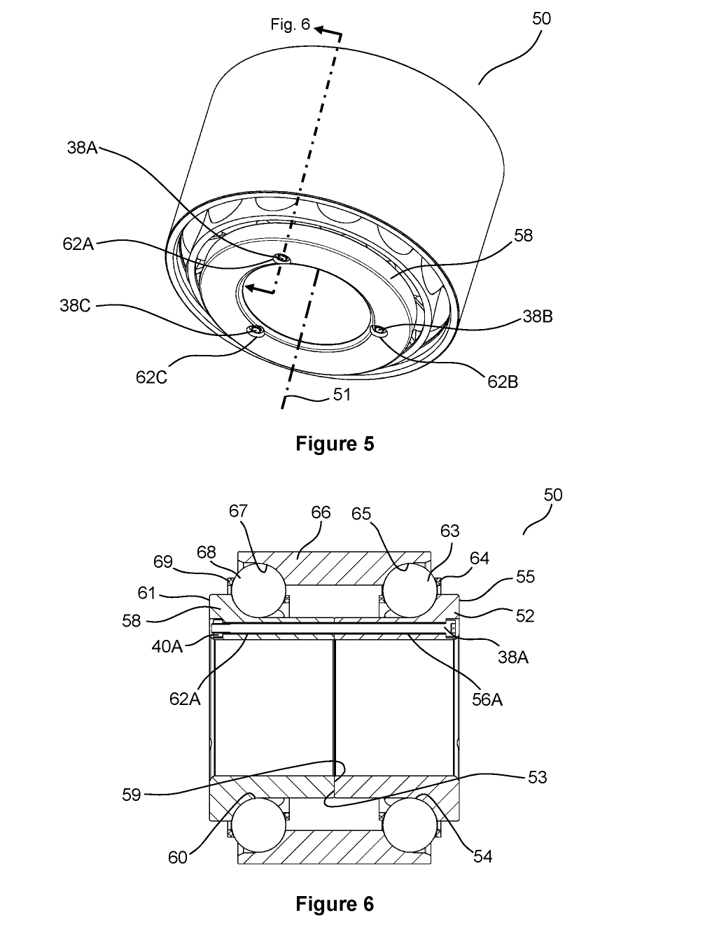

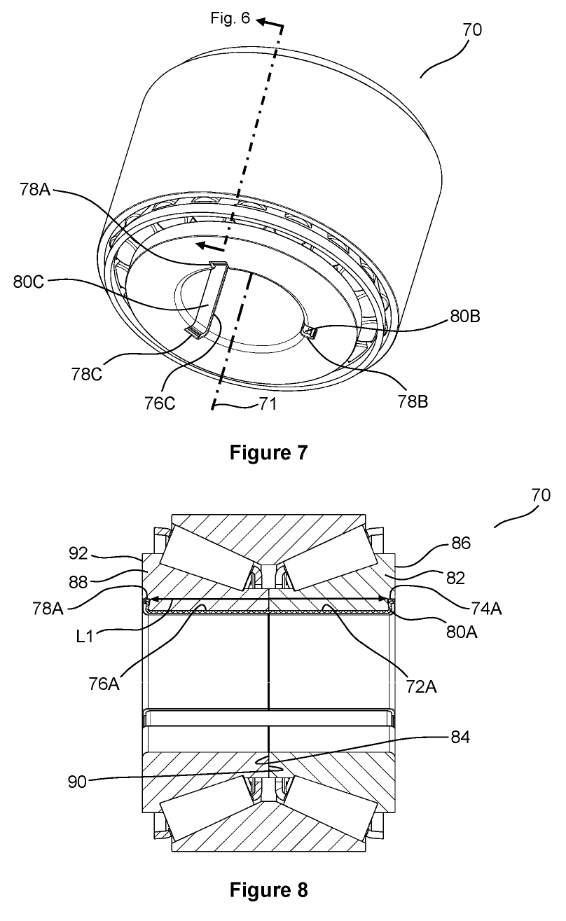

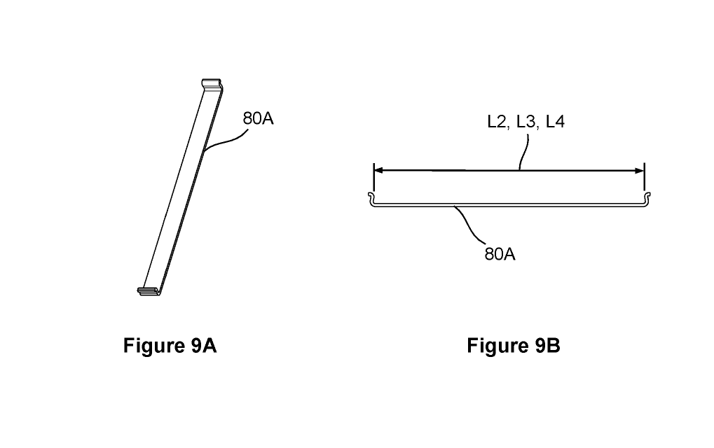

Referring to FIGS. 7 through 9B, a third example embodiment of a bearing assembly 70 is shown that rotates about central axis 71. In this third example embodiment, coupling elements in the form of retention clips 80A,80B,80C are utilized to set the end-play or pre-load of the bearing assembly 50. A first inner ring 82 includes first grooves 72A,72B,72C (only 72A is shown) that extend from the first axial face 84 to the second axial face 86 and a second inner ring 88 includes second grooves 76A,76B,76C (only 76A and 76C are shown) that extend from a third axial face 90 to a fourth axial face 92. The second grooves 76A,76B,76C are aligned with the first grooves 72A,72B,72C. The number of grooves and corresponding retention clips can vary depending on the needs of the application. The retention clips 80A,80B,80C are disposed within the first grooves 72A,72B,72C and second grooves 76A,76B,76C. First clip landings 74A,74B,74C (only 74A is shown) are present on the second axial face 86 of the first inner ring 82 to receive one end of the retention clips 80A,80B,80C. Second clip landings 78A,78B,78C are present on the fourth axial face 92 of the second inner ring 88 to receive the opposite end of the retention clips 80A,80B,80C. With this third example embodiment, different lengths of retention clips 80A,80B,80C could be selected to vary the magnitude of clamp load of the first and second inner rings 82,88 in order to set the end-play or pre-load to a desired range. For example, a distance L1 could be measured between a first clip landing 74A and a second clip landing 78A. A retention clip 80A of a pre-measured length L2,L3,L4 could be selected to achieve a desired end-play or pre-load for the bearing assembly 70.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

What we claim is:

1. A bearing assembly comprising:
an outer ring having:
a first outer rolling element raceway on a first inner radial surface; and,
a second outer rolling element raceway on a second inner radial surface;
a first inner ring having:
a first inner rolling element raceway on a first outer radial surface;
a second inner ring having:
a second inner rolling element raceway on a second outer radial surface;
a first row of rolling elements arranged between the first outer rolling element raceway and the first inner rolling element raceway;
a second row of rolling elements arranged between the second outer rolling element raceway and the second inner rolling element raceway; and,
at least one coupling element received by the first and second inner rings, the at least one coupling element configured to set a pre-load or end-play of the bearing assembly to a pre-determined range.

2. The bearing assembly of claim 1, wherein a force applied by the at least one coupling element is variable to adjust the pre-load or end-play of the bearing assembly.

3. The bearing assembly of claim 1, wherein:
the first outer rolling element raceway and the first inner rolling element raceway are configured to receive a first axial load; and,
the second outer rolling element raceway and the second inner rolling element raceway are configured to receive a second axial load.

4. The bearing assembly of claim 1, wherein:
the first and second outer rolling element raceways and the first and second inner rolling element raceways are tapered roller raceways; and,
the rolling elements are tapered rollers.

5. The bearing assembly of claim 1, wherein:
the first and second outer rolling element raceways and the first and second inner rolling element raceways are angular contact ball raceways; and,
the rolling elements are balls.

6. The bearing assembly of claim 1, further comprising:
at least one first aperture extending from a first axial face to a second axial face of the first inner ring; and,
at least one second aperture, aligned with the at least one first aperture, extending from a third axial face to a fourth axial face of the second inner ring;
wherein, the at least one coupling element is disposed within the at least one first aperture and the at least one second aperture.

7. The bearing assembly of claim 6, wherein the at least one coupling element is a fastener.

8. The bearing assembly of claim 1, further comprising:
at least one first groove, extending from a first axial face to a second axial face on an inner diameter of the first inner ring; and,
at least one second groove, aligned with the at least one first groove and extending from a third axial face to a fourth axial face on an inner diameter of the second inner ring.

9. The bearing assembly of claim 8, wherein the at least one coupling element is a retention clip.

10. The bearing assembly of claim 9, further comprising:
at least one first landing on the second axial face to receive a first end of the at least one retention clip; and,
at least one second landing on the fourth axial face to receive a second end of the at least one retention clip.

11. The bearing assembly of claim 10, wherein the at least one coupling element has a pre-determined length and is selected to adjust a pre-load or end-play of the bearing assembly.

12. The bearing assembly of claim 1, wherein the first axial face of the first inner ring abuts with the third axial face of the second inner ring.

13. The bearing assembly of claim 1, wherein a gap is present between the first axial face of the first inner ring and the third axial face of the second inner ring.

14. The bearing assembly of claim 1, wherein a ring is present between the first axial face of the first inner ring and the third axial face of the second inner ring.

15. The bearing assembly of claim 1, further comprising a first cage arranged between the first outer rolling element raceway and the first inner rolling element raceway, having pockets configured to receive and circumferentially space the first row of rolling elements.

16. The bearing assembly of claim 1, further comprising a second cage arranged between the second outer rolling element raceway and the second inner rolling element raceway, having pockets configured to receive and circumferentially space the second row of rolling elements.
